(19) United States
(12) Patent Application Publication
(10) Pub. No.: US 2007/0036326 A1
(43) Pub. Date: Feb. 15, 2007

(54) SS7 network having wireline and failover Internet protocol (IP) SS7 links

(75) Inventor: Shadi Khoshaba, Skokle, IL (US)

Correspondence Address: BROOKS KUSHMAN P.C., 1000 TOWN CENTER, TWENTY-SECOND FLOOR, SOUTHFIELD, MI, 48075, US

(73) Assignee: SBC Knowledge Ventures, L.P., Reno, NV (US)

(21) Appl. No.: 11/194,888

(22) Filed: Aug. 1, 2005

(51) Int. Cl. H04M 7/00

(52) U.S. Cl. 379/229

(57) ABSTRACT

A signaling system 7 (SS7) network includes wireline and failover Internet Protocol (IP) SS7 links for a communication network having a switched voice network. The SS7 network provides a failover connectivity model which uses an IP data network to provide IP SS7 signaling backup for failed wireline SS7 links. Signaling points of the SS7 network are interconnected by wireline and IP SS7 links. The IP SS7 link connectivity between two signaling points takes the place of the wireline SS7 link connectivity between these signaling points upon the wireline SS7 link connectivity failing. For example, upon the wireline SS7 link connectivity between a central office (CO) signaling point and another signaling point failing, an IP data network provides IP SS7 link connectivity between these signaling points. As a result, the CO is not isolated because of the wireline SS7 link connectivity failure and telephone calls handled by the CO are uninterrupted.

### BACKGROUND OF THE INVENTION

1. Field of the Invention

The present invention relates to signaling system 7 (SS7) networks.

2. Background Art

A signaling system 7 (SS7) network is used for performing out-of-band signaling for switched voice networks. A SS7 network is a separate network laid over a switched voice network(s) such as the public switched telephone network (PSTN) and the public land mobile network (PLMN). A SS7 network is a private network required to route telephone calls that connect telephone users belonging to different central offices of the switched voice networks. A SS7 network is also a platform upon which other telecommunications services such as local number portability are transported.

A SS7 network includes interconnected signaling points such as signal transfer points (STPs), service switching points (SSPs), and service control points (SCPs). STPs route queries and responses between switched voice network switches (i.e., central offices) and the SCPs. The SCPs have databases which contain call routing instructions. The SSPs are associated with the central offices and communicate with the SCP databases.

Dedicated wireline SS7 links interconnect the signaling points in a SS7 network. Some pairs of signaling points are interconnected by redundant (i.e., two or more) wireline SS7 links. Redundant wireline SS7 links between two signaling points ensure that at least one of the wireline SS7 links is operable in the event that any of the other wireline SS7 links fail.

For example, a central office SSP (CO SSP) has two to four wireline SS7 links which are diversely routed through different transport facilities from the CO SSP to another signaling point. These wireline SS7 links provide diverse signaling communications paths between the CO SSP and the other signaling point. Multiple diverse signaling communications paths between the CO SSP and the other signaling point are likely not to fail at the same time thereby ensuring that a signaling communications path between the CO SSP and the other signaling point is available at all times. If all of these communications paths between the CO SSP and the other signaling point should fail at the same time, then this results in the CO being isolated from the other signaling point (i.e., no inter-switch calls can be placed or received by the CO).

Sometimes the wireline SS7 links between two signaling points are not diversely routed between different communications paths but are instead transported over the same transport facility. For example, a CO SSP and another signaling point may be interconnected by multiple wireline SS7 links routed through the same transport facility. If the transport facility fails, then this results in the CO being isolated from the other signaling point.

A CO which is isolated from other signaling points and is thereby prevented from communicating SS7 messages to the other signaling points results in the disruption of telephone calls handled by the CO. Such outages may result in the communications provider responsible for the CO being fined by the FCC.

### BRIEF DESCRIPTION OF THE DRAWINGS

The present invention is pointed out with particularity in the appended claims. However, other features of the present invention will become more apparent and the present invention will be best understood by referring to the following detailed description in conjunction with the accompanying drawings in which:

FIG. 1 illustrates a communications network having a switched voice network overlaid with a signaling system 7 (SS7) network having wireline and failover Internet Protocol (IP) SS7 links in accordance with the present invention;

FIG. 2 illustrates the wireline and IP SS7 link connectivity between a central office and two signal transfer points (STPs) of the SS7 network having wireline and failover IP SS7 links in accordance with the present invention;

FIG. 3 illustrates a communications network having two switched voice networks overlaid with a SS7 network having wireline and failover IP SS7 links in accordance with the present invention;

FIG. 4 illustrates in greater detail a signaling point of the SS7 network having wireline and failover IP SS7 links in accordance with the present invention;

FIG. 5 illustrates a flow chart describing SS7 signaling operation between signaling points of the SS7 network having wireline and failover IP SS7 links in accordance with the present invention; and

FIG. 6 illustrates a a diagrammatical representation of a machine in the form of a computer system within which a set of instructions, when executed, causes the machine to perform any one or more of the methodologies in accordance with the present invention.

### DETAILED DESCRIPTION OF THE PREFERRED EMBODIMENT(S)

The present invention provides a signaling system 7 (SS7) network having wireline and failover Internet Protocol (IP) SS7 links for a communication network having a switched voice network(s). The SS7 network in accordance with the present invention overlays the switched voice network(s). As such, the communications network includes the switched voice network(s) overlaid by the SS7 network in accordance with the present invention. The SS7 network in accordance with the present invention provides a failover connectivity model which uses an IP data network to provide IP SS7 signaling backup for failed wireline SS7 links. As a result, the number of signaling point isolations and central 6office (CO) isolations due to wireline SS7 link failures is mitigated.

The SS7 network in accordance with the present invention provisions for an IP data network based backup service for wireline SS7 links. The SS7 network in accordance with the present invention employs an IP data network such as SBC's secure data communications network (DCN—SBC's NONet) for providing failover IP SS7 link connectivity between signaling points. As such, signaling points of the SS7 network in accordance with the present invention are interconnected by wireline and IP SS7 links. The IP SS7 link connectivity between two signaling points takes the place of the wireline SS7 link connectivity between the two signaling points upon the wireline SS7 link connectivity failing. For example, upon the wireline SS7 link connectivity between a CO SSP and an STP failing, the IP data network provides IP SS7 link connectivity between the CO SSP and the STP. As a result, the CO is not isolated because of the wireline SS7 link connectivity failure and the telephone calls handled by the CO remain uninterrupted.

In the SS7 network in accordance with the present invention, a telecommunications node such as a CO automatically switches over to a “n+1” SS7 link (“n”=the wireline SS7 link set; “n+1”=the IP SS7 link) using SS7 link priority functions once the node determines that its primary SS7 communications paths provided by the wireline SS7 link set are unavailable. Upon the n+1 SS7 link (i.e., the IP SS7 link) between the node and another signaling point (such as an STP) being activated, the IP SS7 link terminates into a mediation device that converts/encapsulates the SS7 message (which was generated in the straight SS7 protocol used by wireline SS7 links for transporting SS7 messages between signaling points) into an SS7oIP based transport protocol for IP delivery from the node to the STP via an IP data network. Depending on the type of STP, the SS7 messages received by the STP may or may not have to be mediated back to the straight SS7 protocol.

The advantages associated with the SS7 network in accordance with the present invention are numerous. For example, the SS7 network in accordance with the present invention makes switched voice networks more dependable. The SS7 network in accordance with the present invention requires relatively small capital investment, utilizes the benefits of existing SS7 networks, and improves reliability of switched voice networks while moving the switched voice networks towards an IP based switching environment.

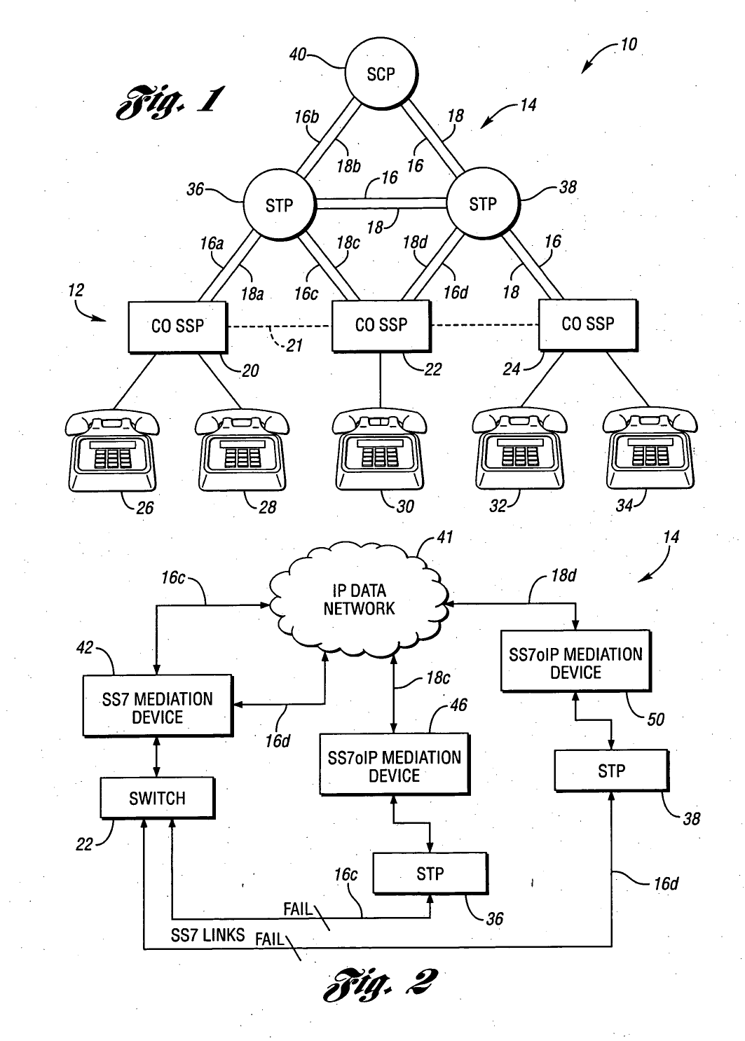

Referring now to FIG. 1, a communications network 10 having a switched voice network 12 overlaid with a SS7 network 14 having wireline SS7 links 16 and failover IP SS7 links 18 in accordance with the present invention is shown. Switched voice network 12 is part of the public switched telephone network (PSTN) and includes central offices (COs) 20, 22, and 24. Each CO 20, 22, and 24 directly connects with telephones serviced by that CO. For instance, telephones 26 and 28 directly connect to CO 20; telephone 30 directly connects to CO 22; and telephones 32 and 34 directly connect to CO 24. CO 20 establishes a switch connection within itself to connect telephones 26 and 28 to one another when users of these telephones call one another, and CO 24 establishes a switch connection within itself to connect telephones 32 and 34 to one another when users of these telephones call one another. COs 20, 22, and 24 establish switch connections through one another to connect together telephones directly connected to different ones of the COs when users of these telephones call one another. For instance, COs 20 and 22 establish a switch connection 21 through one another to connect together telephone 26 (directly connected to CO 20) and telephone 30 (directly connected to CO 22) when users of these telephones call one another.

SS7 network 14 provides SS7 functionality to switched voice network 12. For example, SS7 network 14 communicates SS7 signals to COs 20 and 22 in order for these COs to establish switch connection 21 through one another to connect telephones 26 and 30. That is, SS7 network 14 communicates SS7 signals to COs 20 and 22 in order to control, route, establish, and maintain a telephone call between telephones 26 and 30 via these COs. SS7 network 14 includes signaling points such as signal transfer points (STPs) 36 and 38, service control point (SCP) 40, and service switching points (SSPs) which are operable for communicating SS7 signals. The signaling points are interconnected with one another in order to communicate SS7 signals to one another. The SSPs are respectively part of COs 20, 22, and 24. As such, CO SSPs 20, 22, and 24 communicate SS7 signals with SCP 40 via STPs 36 and 38 in order to control, route, establish, and maintain telephone calls between telephones 26, 28, 30, 32, and 34 via the COs.

The signaling points of SS7 network 14 are interconnected with one another by a wireline SS7 link set 16 and an IP SS7 link 18. A wireline SS7 link set 16 interconnecting two signaling points of SS7 network 14 includes two or more wireline SS7 links 16 which are routed between these signaling points via a single transport facility or via different transport facilities. (Alternatively, a single wireline SS7 link 16 interconnects two signaling points of SS7 network 14.)

In accordance with the present invention, an IP SS7 link 18 interconnecting two signaling points provides a failover SS7 link between these signaling points during the time that wireline SS7 link set 16 between these signaling points fails. During failure of a wireline SS7 link set 16, none of the wireline SS7 links in the link set are available for communicating SS7 signals between signaling points. During this time, in accordance with the present invention, SS7 signals are communicated between signaling points via the IP SS7 link 18 interconnecting the signaling points. As soon as one or more of the wireline SS7 links 16 interconnecting the signaling points is recovered then SS7 signals are communicated between these signaling points via one of the recovered wireline SS7 links instead of being communicated between these signaling points via IP SS7 link 18 interconnecting these signaling points.

For example, CO SSP 20 and STP 36 are interconnected by a wireline SS7 link 16a and an IP SS7 link 18a. Under normal operational conditions, CO SSP 20 communicates SS7 signals with STP 36 via wireline SS7 link 16a in order to communicate SS7 signals with SCP 40. As such, CO 20 is not isolated from communicating SS7 signals with the signaling points of SS7 network 14 under normal operating conditions. However, SS7 signals cannot be communicated over wireline SS7 link 16a under abnormal operating conditions when wireline SS7 link 16a fails. As such, during this time, CO SSP 20 will be isolated from communicating SS7 signals with other signaling points if there are no other functional SS7 links available for the CO SSP 20 to use to communicate SS7 signals.

In accordance with the present invention, IP SS7 link 18a effectively steps in for and temporarily replaces wireline SS7 link 16a while the wireline SS7 link has failed to thereby prevent CO SSP 20 from being isolated from communicating SS7 signals to/from the other signaling points in SS7 network 14. As soon as wireline SS7 link 16a is operational after its failure, then wireline SS7 link 16a is reenabled in place of IP SS7 link 18a to thereby communicate SS7 signals between CO SSP 20 and the other signaling points in SS7 network 14.

As another example, a wireline SS7 link 16b and an IP SS7 link 18binterconnect STP 36 and SCP 40. STP 36 and SCP 40 communicate SS7 signals with one another via wireline SS7 link 16b while the wireline SS7 link is functional. In accordance with the present invention, STP 36 and SCP 40 communicate SS7 signals with one another via IP SS7 link 18b while wireline SS7 link 16b is not functional. As such, STP 36 and SCP 40 are not isolated from communicating SS7 signals with one another during all times (i.e., during the time that wireline SS7 link 16b is functional and during the time that wireline SS7 link 16b is not functional).

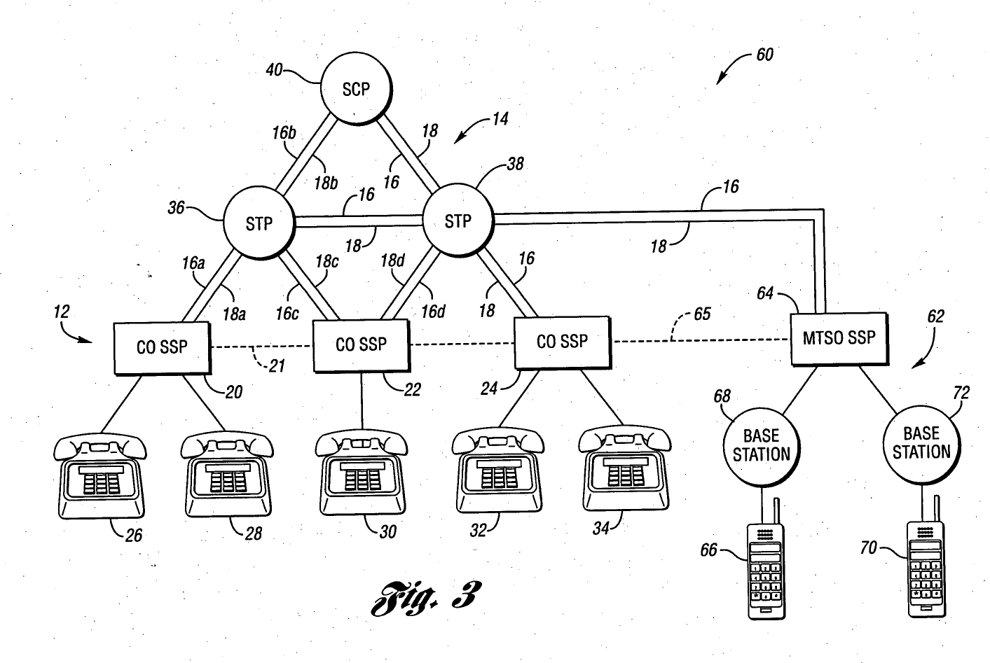

Referring now to FIG. 2, with continual reference to FIG. 1, the wireline and IP SS7 link connectivity between a CO such as CO SSP 22 (“switch”) and two other signaling points such as STPs 36 and 38 of SS7 network 14 is shown. As described with reference to FIG. 1, a wireline SS7 link 16c and an IP SS7 link 18c interconnect CO SSP 22 and STP 36, and a wireline SS7 link 16d and an IP SS7 link 18d interconnect CO SSP 22 and STP 38. During normal operational conditions, CO SSP 22 and STP 36 communicate SS7 signals with one another via wireline SS7 link 16c. Likewise, during normal operational conditions, CO SSP 22 and STP 38 communicate SS7 signals with one another via wireline SS7 link 16d. Upon wireline SS7 link 16c failing, CO SSP 22 and STP 36 communicate SS7 signals with one another via IP SS7 link 18c. As soon as wireline SS7 link 16c has been restored, CO SSP 22 and STP 36 then communicate SS7 signals with one another via wireline SS7 link 16c. Likewise, upon wireline SS7 link 16d failing, CO SSP 22 and STP 38 communicate SS7 signals with one another via IP SS7 link 18d. As soon as wireline SS7 link 16d has been restored, CO SSP 22 and STP 38 then communicate SS7 signals with one another via wireline SS7 link 16d.

As shown in FIG. 2, IP SS7 links 18c and 18d are part of an IP data network 41. To this end, CO SSP 22 is associated with a SS7 mediator 42, and STPs 36 and 38 are respectively associated with SS7oIP mediators 46 and 50. Accordingly, IP SS7 link 18c between CO SSP 22 and STP 36 runs through IP data network 41 and terminates on one end to SS7 mediator 42 and terminates on its other end to SS7oIP mediator 46. Similarly, IP SS7 link 18d between CO SSP 22 and STP 38 runs through IP data network 41 and terminates on one end to SS7 mediator 42 and terminates on its other end to SS7oIP mediator 50.

CO SSP 22 and STPs 36 and 38 communicate SS7 signals between one another via wireline SS7 links 16c and 16d using a conventional SS7 protocol. CO SSP 22 and STPs 36 and 38 communicate SS7 signals between one another via IP SS7 links 18c and 18d using an SS7oIP based transport protocol. To this end, mediators 42, 46, and 48 convert/encapsulate SS7 signals generated in accordance with the conventional SS7 protocol to the SS7oIP based transport protocol for delivery through IP data network 41 over IP SS7 links 18c and 18d. Similarly, mediators 42, 46, and 48 de-convert/de-encapsulate SS7 signals received from IP data network 41 over IP SS7 links 18c and 18d to the conventional SS7 protocol from the SS7oIP based transport protocol.

For example, CO SSP 22 generates a SS7 signal using the conventional SS7 protocol for receipt by STP 36 via IP SS7 link 18c running through IP data network 41. SS7 mediator 42 receives the SS7 signal and then converts/encapsulates the SS7 signal to the SS7oIP based transport protocol. SS7 mediator 42 then transmits the converted/encapsulated SS7 signal through IP SS7 link 18c running through IP data network 41 for receipt by STP 36. SS7oIP mediator 46 receives the converted/encapsulated SS7 signal from IP SS7 link 18c running through IP data network 41 and then de-converts/de-encapsulates the SS7 signal back to the conventional SS7 protocol. SS7oIP mediator 46 then provides the SS7 signal, which has been converted back to the conventional SS7 protocol, to STP 36.

SS7 mediator 42 and SS7oIP mediators 46 and 50 also perform converse mediation functions. For example, SS7 mediator 42 functions as a SS7oIP mediator for de-converting/de-encapsulating SS7 signals from the SS7oIP based transport protocol to the conventional SS7 protocol. Similarly, SS7oIP mediators 46 and 50 function as a SS7 mediator for converting/encapsulating SS7 signals from the conventional SS7 protocol to the SS7oIP based transport protocol. As such, the conversion/encapsulation and de-conversions/de-encapsulation processes described above are repeated, for example, when STP 36 communicates a SS7 signal back to CO SSP 22 via IP SS7 link 18c running through IP data network 41.

Accordingly, as shown in FIG. 2, the IP backup service uses IP data communications services to connect the central office SS7 network to the STPs. As such, the present invention provides for an IP data communications central office network based backup service for SS7.

Referring now to FIG. 3, with continual reference to FIG. 1, a communications network 60 having switched voice networks 12 and 62 overlaid with SS7 network 14 in accordance with the present invention is shown. As noted, switched voice network 12 is part of the PSTN and includes COs 20, 22, and 24. Switched voice network 62 is a cellular telephone switched voice network and is part of the PLMN. Switched voice network 62 includes mobile telephone switching offices (MTSOs) such as a MTSO 64. MTSOs are analogous to central offices.

MTSO 64 wirelessly connects with cellular phones serviced by MTSO 64 via base stations (i.e., cellular antennas). For instance, cellular phone 66 wirelessly connects with MTSO 64 via a base station 68, and cellular phone 70 wirelessly connects with MTSO 64 via a base station 72. MTSO 64 establishes a switch connection within itself to connect cellular phones 66 and 70 to one another when users of these cellular phones call one another. MTSO 64 establishes switch connections with COs of the PSTN in order to connect together cellular phones with telephones or with other cellular phones. For example, MTSO 64 and CO 24 establish a switch connection 65 through one another to connect together cellular phone 66 (serviced by MTSO 64) and telephone 32 (serviced by CO 24).

SS7 network 14 provides SS7 functionality to both switched voice networks 12 and 62. For example, SS7 network 14 communicates SS7 signals to MTSO 64 for the MTSO to use in order to establish cellular telephone calls between cellular phones serviced by the MTSO and other cellular phones serviced by other MTSOs. Likewise, SS7 network 14 communicates SS7 signals to CO 24 and MTSO 64 in order for these offices to establish switch connection 65 through one another for connecting telephone 32 and cellular phone 66. To this end, an SSP of SS7 network 14 is part of MTSO 64 just like other SSPs of the SS7 network are respectively part of COs 20, 22, and 24. As such, MTSO SSP 64 communicates SS7 signals with SCP 40 via STP 38 just like CO SSPs 20, 22, and 24 communicate SS7 signals with SCP 40 via STPs 36 and 38 in order to control, route, and maintain calls between the telephones and cellular phones of switched voice networks 12 and 62.

MTSO SSP 64 is connected to STP 38 by a wireline SS7 link set 16 and an IP SS7 link 18 in order to communicate SS7 signals with the signaling points of SS7 network 14. IP SS7 link 18 interconnecting MTSO SSP 64 to STP 38 provides a failover SS7 link between these signaling points during the time that wireline SS7 link set 16 between these signaling points fails. As soon as any of the wireline SS7 links of wireline SS7 link set 16 interconnecting MTSO SSP 64 and STP 38 has been recovered then SS7 signals are communicated between these signaling points via one of the recovered wireline SS7 links. As such, MTSO SSP 64 is not isolated from communicating SS7 signals with the other signaling points of SS7 network 14 while wireline SS7 link set 16 associated with the MTSO SSP is in a failure condition.

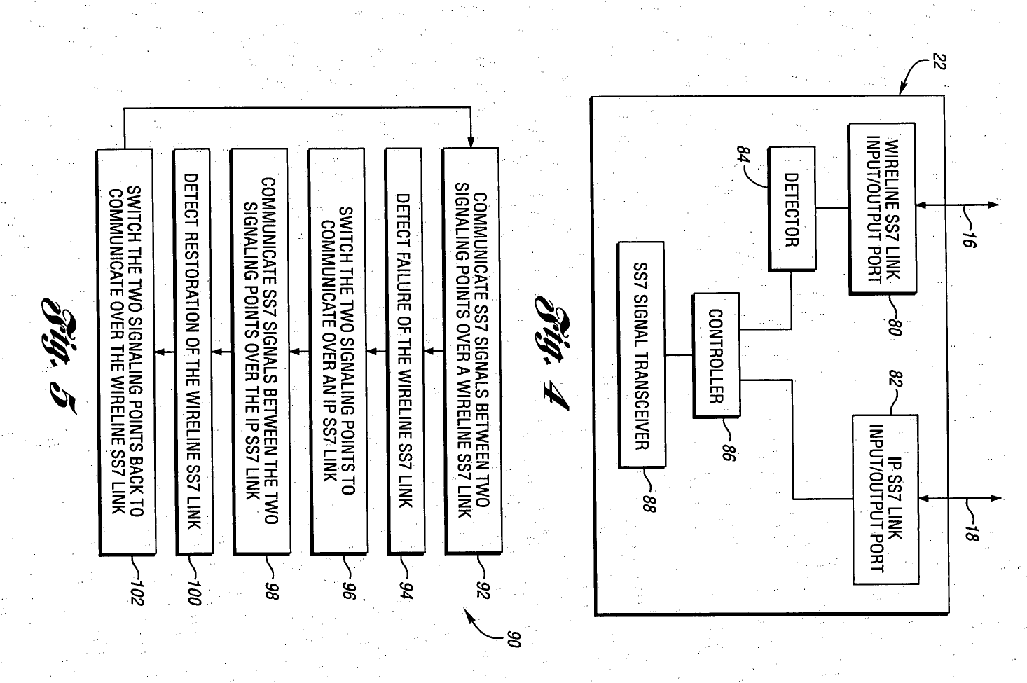

Referring now to FIG. 4, with continual reference to FIGS. 1 and 2, a signaling point of SS7 network 14 in accordance with the present invention is shown in more detail. The signaling point, such as CO SSP 22, includes a wireline SS7 link input/output port 80 for inputting/outputting SS7 signals from/to wireline SS7 link(s) 16, and includes an IP SS7 link input/output port 82 for inputting/outputting SS7 signals from/to IP SS7 link 18. The signaling point further includes a detector 84. Detector 84 detects whether the wireline connection over wireline SS7 link(s) 16 is properly established and continuously monitors the wireline connection to determine if the wireline connection has been lost or restored. For example, detector 84 monitors the SS7 signals received over wireline SS7 link(s) 16 from another signaling point to which CO SSP 22 is connected, and when no SS7 signal is received via wireline SS7 link(s) 16 in response to an SS7 signal generated by the CO SSP for the other signaling point during a predetermined time period then the detector detects a connectivity failure.

The signaling point further includes a controller 86 and a SS7 signal transceiver 88. SS7 signal transceiver 88 generates SS7 signals using the conventional SS7 protocol for transmission to other signaling points via ports 80 and 82. Likewise, SS7 signal transceiver 88 receives SS7 signals generated in accordance with the conventional SS7 protocol received from other signaling points via ports 80 and 82. Controller 86 switches SS7 signal transceiver 88 to connect with one of ports 80 and 82 at any one time depending on which of wireline and IP SS7 links 16 and 18 are to be used for communicating SS7 signals to/from CO SSP 22. For instance, controller 86 connects SS7 signal transceiver 88 to wireline SS7 input/output port 80 when SS7 signals are to be communicated over wireline SS7 link(s) 16. Likewise, controller 86 connects SS7 signal transceiver 88 to IP SS7 input/output port 82 when SS7 signals are to be communicated over IP SS7 link 18. As such, controller 86 connects SS7 signal transceiver 88 to one of wireline and IP SS7 links 16 and 18 at any one time depending on the operational status of wireline SS7 link(s) 16 as detected by detector 84.

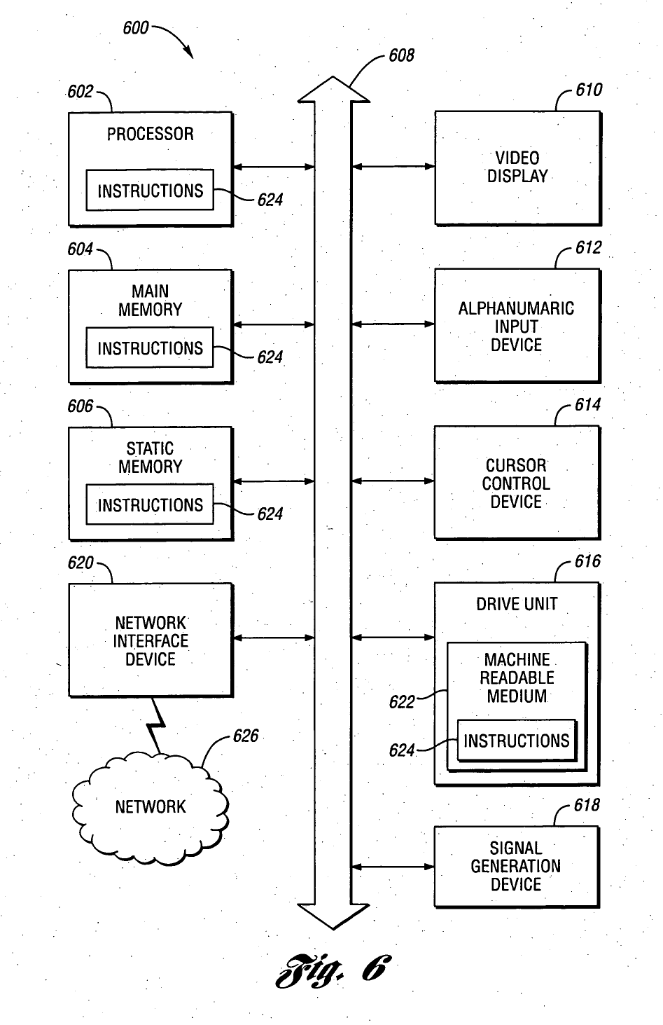

Referring now to FIG. 5, with continual reference to FIGS. 1 and 2, a flowchart 90 describing SS7 signaling operation between signaling points of SS7 network 14 is shown. The SS7 signaling operation initially includes two signaling points (such as CO SSP 24 and STP 38) of SS7 network 14 communicating SS7 signals over a wireline SS7 link 16 between these signaling points as shown in block 92. Detectors of these signaling points monitor wireline SS7 link 16 to determine whether the wireline SS7 link has failed. Alternatively, other means may be employed for monitoring wireline SS7 link 16 to determine whether the wireline SS7 link has failed. For instance, wireline SS7 link 16 is transported over a transport facility. The transport facility may have various detection mechanisms which provide indications regarding the status of the elements of the transport facility (including wireline SS7 link 16 itself) which are relevant to the operational condition of the wireline SS7 link. Either or both of the signaling points or other signaling points receive such indications in order for signaling points in the SS7 network to be made aware of the operational status of wireline SS7 link 16. As such, the SS7 signaling operation further includes detecting failure of wireline SS7 link 16 as shown in block 94.

Upon the failure of wireline SS7 link 16 being detected, the two signaling points are switched over to an IP SS7 link 18 interconnecting these signaling points as shown in block 96. That is, IP SS7 link 18 temporarily takes the place of wireline SS7 link 16 upon the wireline SS7 link failing. The two signaling points then communicate SS7 signals over IP SS7 link 18 (which runs through IP data network 41) as shown in block 98. While SS7 signals are being communicated over IP SS7 link 18, the SS7 signaling operation further includes detecting the operational status of wireline SS7 link 16 to determine if the wireline SS7 link has been restored as shown in block 100. Upon restoration of wireline SS7 link 16, the two signaling points are switched back to the wireline SS7 link as shown in block 102. That is, wireline SS7 link 16 retakes its place and IP SS7 link 18 is regulated to its backup role. The SS7 signaling operation then continues with SS7 signals being communicated between the two signaling points over wireline SS7 link 16 as shown in block 92.

Referring now to FIG. 6, a diagrammatic representation of a machine in the form of a computer system 600 is shown within which a set of instructions, when executed, may cause the machine to perform any one or more of the methodologies discussed herein. In some embodiments, the machine operates as a standalone device. In some embodiments, the machine may be connected (e.g., using a network) to other machines. In a networked deployment, the machine may operate in the capacity of a server or a client user machine in server client user network environment, or as a peer machine in a peer-to-peer (or distributed) network environment. The machine may include a server computer, a client user computer, a personal computer (PC), a tablet PC, a set-top box (STB), a Personal Digital Assistant (PDA), a cellular telephone, a mobile device, a palmtop computer, a laptop computer, a desktop computer, a personal digital assistant, a communications device, a wireless telephone, a land-line telephone, a control system, a camera, a scanner, a facsimile machine, a printer, a pager, a personal trusted device, a web appliance, a network router, switch or bridge, or any machine capable of executing a set of instructions (sequential or otherwise) that specify actions to be taken by that machine. It will be understood that a device of the present invention includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

Computer system 600 may include a processor 602 (e.g., a central processing unit (CPU), a graphics processing unit (GPU), or both), a main memory 604 and a static memory 606, which communicate with each other via a bus 608. Computer system 600 may further include a video display unit 610 (e.g., a liquid crystal display (LCD), a flat panel, a solid state display, or a cathode ray tube (CRT)). Computer system 600 may include an input device 612 (e.g., a keyboard), a cursor control device 614 (e.g., a mouse), a disk drive unit 616, a signal generation device 618 (e.g., a speaker or remote control) and a network interface device 620.

Disk drive unit 616 may include a machine-readable medium 622 on which is stored one or more sets of instructions (e.g., software 624) embodying any one or more of the methodologies or functions described herein, including those methods illustrated in herein above. Instructions 624 may also reside, completely or at least partially, within main memory 604, static memory 606, and/or within processor 602 during execution thereof by computer system 600. Main memory 604 and processor 602 also may constitute machine-readable media. Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present invention, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present invention contemplates a machine readable medium containing instructions 624, or that which receives and executes instructions 624 from a propagated signal so that a device connected to a network environment 626 can send or receive voice, video or data, and to communicate over the network,626 using instructions 624. Instructions 624 may further be transmitted or received over a network 626 via network interface device 620.

While machine-readable medium 622 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the present invention is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the present invention is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and charges may be made without departing from the scope of this disclosure. The Figures are merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method of communicating signaling system 7 (SS7) signals between two signaling points in which the two signaling points are interconnected by a wireline SS7 link, the method comprising:
interconnecting the two signaling points with an Internet Protocol (IP) SS7 link running through an IP data network such that the two signaling points are interconnected by the wireline SS7 link and the IP SS7 link;
monitoring the wireline SS7 link to determine whether the wireline SS7 link is available for communicating SS7 signals between the two signaling points;
upon determining that the wireline SS7 link is unavailable for communicating SS7 signals between the two signaling points, communicating SS7 signals between the two signaling points over the IP SS7 link until the wireline SS7 link is available for communicating SS7 signals between the two signaling points; and
upon determining that the wireline SS7 link is available for communicating SS7 signals between the two signaling points after the wireline SS7 link was unavailable for communicating SS7 signals between the two signaling points, communicating subsequent SS7 signals between the two signaling points over the wireline SS7 link.

2. The method of claim 1 wherein:
the two signaling points include a central office service switching point (CO SSP) and a service transfer point (STP).

3. The method of claim 1 wherein:
the two signaling points include a service transfer point (STP) and a service control point (SCP).

4. The method of claim 1 wherein:
the two signaling points include a mobile telephone switching office service switching point (MTSO SSP) and a service transfer point (STP).

5. The method of claim 1 wherein:
communicating SS7 signals between the two signaling points over the wireline SS7 link includes communicating the SS7 signals in accordance with a conventional SS7 transport protocol;
communicating SS7 signals between the two signaling points over the IP SS7 link includes communicating the SS7 signals in accordance with a SS7oIP based transport protocol.

6. The method of claim 5 wherein:
communicating SS7 signals between the two signaling points over the IP SS7 link includes converting the SS7 signals from the conventional SS7 transport protocol to the SS7oIP based transport protocol for transmission over the IP SS7 link from one of the signaling points to the other of the signaling points and de-converting the SS7 signals from the SS7oIP based transport protocol back to the conventional SS7 transport protocol for reception via the IP SS7 link from the one of the signaling points by the other of the signaling points.

7. The method of claim 1 wherein:
the wireline SS7 link is routed through a transport facility, wherein monitoring the wireline SS7 link to determine whether the wireline SS7 link is available for communicating SS7 signals between the two signaling points includes monitoring the transport facility to determine whether the wireline SS7 link is available for communicating SS7 signals between the two signaling points.

8. A method of communicating signaling system 7 (SS7) signals between two SS7 network signaling points in which the signaling points are interconnected by wireline SS7 links diversely routed through different wireline transport facilities, the method comprising: interconnecting the signaling points with an Internet Protocol (IP) SS7 link routed through an IP data network such that the signaling points are interconnected by the wireline SS7 links and by the IP SS7 link;
monitoring the wireline SS7 links to determine whether any of the wireline SS7 links are available for communicating SS7 signals between the signaling points;
communicating SS7 signals between the signaling points over any one of the available wireline SS7 links;
upon determining that none of the wireline SS7 links are available for communicating SS7 signals between the signaling points, communicating subsequent SS7 signals between the signaling points over the IP SS7 link until at least one of the wireline SS7 links is available for communicating SS7 signals between the signaling points; and
upon determining that at least one of the wireline SS7 links is available for communicating SS7 signals between the signaling points after all of the wireline SS7 links were unavailable for communicating SS7 signals between the signaling points, communicating subsequent SS7 signals between the signaling points over any one of the available wireline SS7 links.

9. The method of claim 8 wherein:
the signaling points include either a central office service switching point (CO SSP) or a mobile telephone switching office service switching point (MTSO SSP), and a service transfer point (STP).

10. The method of claim 8 wherein:
the signaling points include a service transfer point (STP) and a service control point (SCP).

11. The method of claim 8 wherein:
communicating SS7 signals between the signaling points over a wireline SS7 link includes communicating the SS7 signals in accordance with a conventional SS7 transport protocol;
communicating SS7 signals between the signaling points over the IP SS7 link includes communicating the SS7 signals in accordance with a SS7oIP based transport protocol.

12. A communications network comprising:
a voice switched network having a switch;
a signaling system 7 (SS7) network having two signaling points, wherein a first one of the signaling points is associated with the switch of the voice switched network, the SS7 network further having a wireline SS7 link interconnecting the two signaling points, the SS7 network further having an Internet Protocol (IP) SS7 link interconnecting the two signaling points in which the IP SS7 link is routed through an IP data network;
wherein the signaling points communicate SS7 signals between one another over the wireline SS7 link;
wherein upon the wireline SS7 link being interrupted from being able to communicate SS7 signals between the signaling points, the signaling points communicate subsequent SS7 signals between one another over the IP SS7 link until the wireline SS7 link is able to communicate SS7 signals between the signaling points at which time the signaling points communicate further SS7 signals between one another over the wireline SS7 link.

13. The communications network of claim 12 wherein:
the switch is a central office (CO) and the first one of the signaling points associated with the CO is a service switching point (SSP), wherein the second one of the signaling points is a service transfer point (STP).

14. The communications network of claim 12 wherein:
the switch is a mobile telephone switching office (MTSO) and the first one of the signaling points associated with the MTSO is a service switching point (SSP), wherein the second one of the signaling points is a service transfer point (STP).

15. The communications network of claim 12 wherein:
the SS7 network further includes a third signaling point, the SS7 network further having a second wireline SS7 link and a second IP SS7 link interconnecting the second and third signaling points in which the second IP SS7 link is routed through the IP data network, wherein the second and third signaling points communicate SS7 signals between one another over the second wireline SS7 link;
wherein upon the second wireline SS7 link being interrupted from being able to communicate SS7 signals between the second and third signaling points, the second and third signaling points communicate subsequent SS7 signals between one another over the second IP SS7 link until the second wireline SS7 link is able to communicate SS7 signals between these signaling points at which time these signaling points communicate further SS7 signals between one another over the second wireline SS7 link.

16. The communications network of claim 15 wherein:
the switch is either a central office (CO) or a mobile telephone switching office (MTSO), the first one of the signaling points associated with the switch is a service switching point (SSP), the second one of the signaling points is a service transfer point (STP), and the third one of the signaling points is a service control point (SCP).

17. The communications network of claim 12 wherein:
the signaling points communicate SS7 signals between one another over the wireline SS7 link using a conventional SS7 transport protocol, and communicate SS7 signals between one another over the IP SS7 link using a SS7oIP based transport protocol.

18. A computer-readable medium for use in communicating signaling system 7 (SS7) signals between two signaling points in which the two signaling points are interconnected by a wireline SS7 link, the computer-readable medium comprising:
instructions for interconnecting the two signaling points with an Internet Protocol (IP) SS7 link running through an IP data network such that the two signaling points are interconnected by the wireline SS7 link and by the IP SS7 link;
instructions for monitoring the wireline SS7 link to determine whether the wireline SS7 link is available for communicating SS7 signals between the two signaling points;
instructions for communicating subsequent SS7 signals between the two signaling points over the wireline SS7 link while the wireline SS7 link is available for communicating SS7 signals between the two signaling points; and
instructions for communicating SS7 signals between the two signaling points over the IP SS7 link while the wireline SS7 link is unavailable for communicating SS7 signals between the two signaling points.

19. The computer-readable medium of claim 1 wherein:
the instructions for communicating SS7 signals between the two signaling points over the wireline SS7 link includes instructions for communicating the SS7 signals over the wireline SS7 link using a conventional SS7 transport protocol;
the instructions for communicating SS7 signals between the two signaling points over the IP SS7 link includes instructions for communicating the SS7 signals over the IP SS7 link using a SS7oIP based transport protocol.

20. The computer-readable medium of claim 19 wherein:
the instructions for communicating SS7 signals between the two signaling points over the IP SS7 link includes instructions for converting the SS7 signals from the conventional SS7 transport protocol to the SS7oIP based transport protocol for transmission over the IP SS7 link and instructions for de-converting the SS7 signals from the SS7oIP based transport protocol back to the conventional SS7 transport protocol for reception over the IP SS7 link.
